(19) United States
(12) Patent Application Publication
(10) Pub. No.: US 2009/0319625 A1
(43) Pub. Date: Dec. 24, 2009

(54) Interactivity in a digital public signage network architecture

(75) Inventor: Ross George Kouhi, Ottawa (CA)

Correspondence Address: ALCATEL-LUCENT, C/O GALASSO & ASSOCIATES, LP, P. O. BOX 26503, AUSTIN, TX, 78755-0503, US

(73) Assignee: ALCATEL LUCENT

(21) Appl. No.: 12/214,769

(22) Filed: Jun. 20, 2008

(51) Int. Cl. G06F 15/16

(52) U.S. Cl. 709/206; 709/219

(57) ABSTRACT

The current invention is a method and device for allowing a customer to interact with a public signage display to obtain additional information about a product or service at a retail location or the like that does not require additional equipment for user interaction attached to the public signage on the retail floor. The current invention involves a connection between the public signage content distribution and its management architecture with the cellular wireless network that can enable flexible, dynamic user interaction with displays in public spaces.

### CROSS REFERENCE TO RELATED APPLICATIONS

This United States Non-Provisional Patent Application does not claim priority to any United States Provisional Patent Application or any foreign patent application.

### FIELD OF THE DISCLOSURE

The disclosures made herein relate generally to the networking domain industry. The invention discussed herein is in the general classification of digital public signage.

### BACKGROUND

Digital Public Signage is an emerging networking domain that describes delivery of content to a plurality of displays across potentially vast geographic spaces. It is often advantageous for a customer to be able to utilize a digital sign in a retail or other similar location to obtain certain information about products or services being sold in that retail location.

In a network that services a retail enterprise or other captive audience environment, direct connections between public relations or marketing professionals, or other content managers (e.g. school curriculum programmers, airport authorities, etc.) and clients/customers provides a one-way means to share information. Given a ubiquity of active display signs, there is an opportunity to enable viewers to interact with a display to get enhanced value.

Interaction previously has occurred awkwardly through an apparatus attached to a sign at a retail location. Typically, in the prior art, a navigation means is attached to the signage to allow interaction between a customer at a retail location and public relations or marketing professionals. This often occurs in a kiosk type environment. This type of solution results in a high cost for the deployment of equipment such as a keyboard and a mouse that must be added to the apparatus.

In addition, when user-interaction is enabled through some attached apparatus, maintenance and repair of the apparatus becomes necessary due to normal wear-and-tear or user abuse.

Such apparatus for user interaction also requires physical space. Many signage displays of conventional printed signs, as well as active display signs, make use of wall space, leaving floor space that is in short supply in an active public space to accommodate movement and merchandise. Accommodating a user interaction area with additional equipment is a challenge.

Some users are also reticent to use a physical apparatus that other strangers have touched and that they conceive may retain grime or microbes due to perceived potential for transmission of colds, influenza and the like.

Some interactive displays also use a touch-screen approach, but these suffer from obscuring of the display due to skin oils and dirt left on the surface by the previous user.

Finally, some displays must be placed in areas where an interconnected apparatus would be physically distant. In such situations, knowing where to find the control apparatus would be a challenge for a potential user.

Hence, there is a need in the art for a convenient to use, reliable, and inexpensive method/device for allowing a customer to interact with a public signage display to obtain additional information about a product or service at a retail location or the like that does not require additional equipment for user interaction attached to the public signage display on the retail floor.

### SUMMARY OF THE DISCLOSURE

The current invention is a method and device for allowing a customer to interact with a public signage display to obtain additional information about a product or service at a retail location or the like that does not require additional equipment for user interaction attached to the public signage display on the retail floor.

The current invention allows a connection between the management architecture and the cellular wireless network that can enable flexible, dynamic user interaction with displays in public spaces.

The rich display properties of modern cellular phones allow for a rich user interface in the user's hand beyond simple key presses. Cellular phone display-based enhancements include interfaces with icons, graphics, and video or audio that can echo advertising elements on the large display.

Many display environments (e.g. retail stores, mall space, airports) have many displays scattered around a single location. Thus, the display is not a scarce resource. If a customer approaches one display and launches an interactive session, that display can be used without depriving the business (and other customers) of the ability to continue presenting/seeing content on the rest of the displays.

The preferred embodiment of this invention proposes that the addressable displays have a unique identifier per display, and a phone number, ‘handle’ or other unique resource indicator. The simplest interaction is launched with a cellular phone call to a posted number, and then the keying in of the unique display number. That display is quickly isolated from the series of displays at the site and an interactive session can be launched, without the session being shared on all the displays in the group.

The interaction with a large display will not be a private session in the preferred embodiment of the invention. The large display size means others will be able to see it as well, if in close proximity. This is not a concern as the interaction is not intended for personal information display (e.g. personal financial information) in the preferred embodiment.

However, the interactivity will make the customer feel more connected to the marketing content on display, and thus potentially more likely to buy. Others seeing the session may also feel compelled to interact with a display and can see when other people have interest in certain classes of product. Given the propensity of people of similar demographics to share interests, this may result in increased sales as well.

Some consumers will be impressed with the ability to interact with a large public display. The impact of being able to take over a large urban billboard for an interaction or browsing the content is an exciting prospect for many consumers.

The intuitive reaction of some to such user interaction with a display is that such interaction would diminish the value of the content displayed, as it is being driven by only one user. However, since all the content that is browseable will be relevant to the product, it all serves the purpose of exposing brands and products to an audience. This invention could dramatically change the way people view billboards and signage. Interaction with billboard type displays changes them from passive things to be ignored to platforms to be scrutinized.

The principal object of this invention is to provide a method and device for allowing a customer to interact with a public signage display to obtain additional information about a product or service at a retail location or the like that does not require additional equipment for user interaction attached to the public signage display on the retail floor.

Another object of this invention is to provide a method and device for allowing a customer to interact with a public signage display to obtain additional information about a product or service at a retail location or the like that does not require excessive maintenance or repair.

Another object of this invention is to provide a method and device for allowing a customer to interact with a public signage display to obtain additional information about a product or service at a retail location or the like that minimizes use of floor space.

Another object of this invention is to provide a method and device for allowing a customer to interact with a public signage display to obtain additional information about a product or service at a retail location or the like that does not require a physically distant kiosk or other apparatus to control the public signage.

Another object of this invention is to provide a method and device for allowing a customer to interact with a public signage display to obtain additional information about a product or service at a retail location or the like that is relatively inexpensive to implement, maintain or manufacture.

Another object of this invention is to provide a reliable method and device for allowing a customer to interact with a public signage display to obtain additional information about a product or service at a retail location or the like that does not require additional equipment for user interaction attached to the public signage on the retail floor.

Another object of this invention is to provide a convenient to use method and device for allowing a customer to interact with a public signage display to obtain additional information about a product or service at a retail location or the like that does not require additional equipment for user interaction attached to the public signage display on the retail floor.

Another object of this invention is to provide a method and device for providing rapid, responsive and adaptable promotional capability that puts marketing and management into direct contact with customers in the most appropriate space-the retail premises.

Another object of this invention is to provide a method and device that allows interacting users with public signage displays to feel connected to and in control of information on the public signage display.

Another object of this invention is to provide a method and device for allowing a customer to interact with a public signage display that minimizes the separation of the point-of-sale at a retail store from the marketing department of the public signage campaign and the separation between the advertising point and the point of purchase.

Another object of the invention is to provide carriers a revenue generating service for public signage displays that can be offered to enterprises, government, institutions and others.

Yet another object of the invention is to provide a method and device for public signage displays that allows governments, institutions and the like to deliver operational content while also providing a means of sending emergency communications in a resilient, centralized architecture.

### BRIEF DESCRIPTION OF THE DRAWINGS

FIG. 1 depicts a diagram of the preferred embodiment of the public signage architecture of the present invention.

FIG. 2 depicts a diagram of the component parts of the networking interface module of the preferred embodiment of the present invention.

FIG. 3 depicts a diagram of an alternative embodiment of the public signage architecture of the present invention.

### DETAILED DESCRIPTION OF THE DRAWINGS

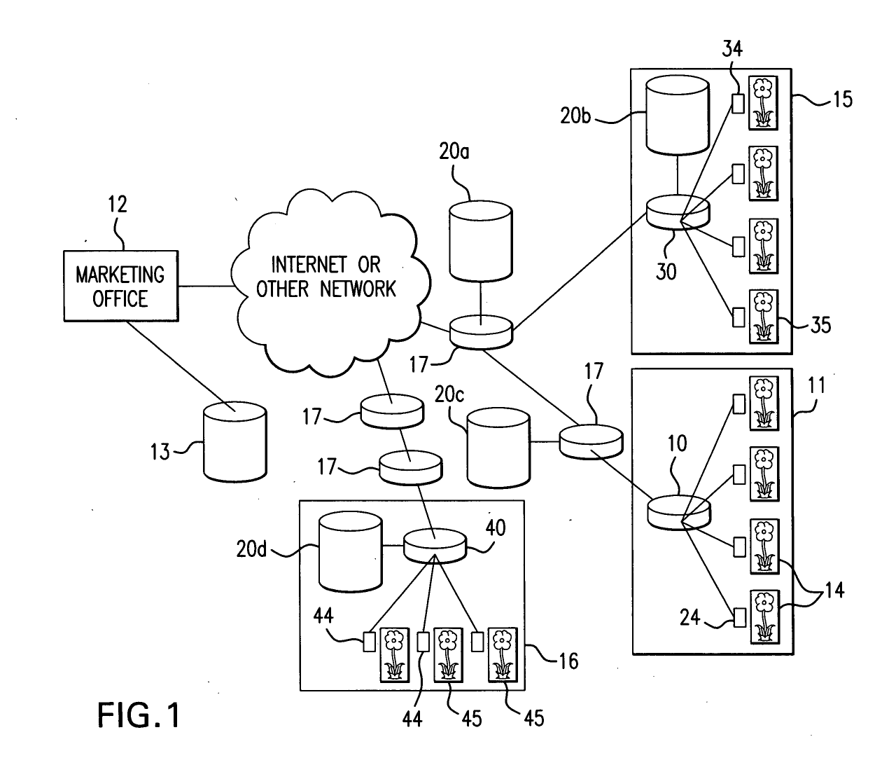

FIG. 1 depicts a diagram of the preferred embodiment of the public signage architecture of the present invention. A plurality of displays 14 are shown for a department store, retail establishment or other entity 11. The displays 14 are the end-user visible elements of the public signage architecture (PSA). Local router 10 connects individual displays 14 through networking interface modules 24 to a network. The networking interface modules 24 can be integrated with the displays 14 or, alternatively, may simply be personal computers, although this would be a more costly and less optimal solution.

This entity 11 may own its own local PSA and accompanying network, but it may also be purchasing the system and service through a carrier or other service provider. A large entity or a carrier solution would include content caching throughout the network, to control transmission costs, and create a more responsive behavior.

A marketing professional in a marketing head office 12 creates a signage campaign and shares it with management. Once approval of the signage campaign is received, the signage campaign is launched. The associated images and content for the signage campaign are sent from the marketing head office 12 to a repository 13 which holds content and associated display timing and navigation information, accessible through the network by retail locations such as entity 11.

The associated images and content for a signage campaign are sent from a central cache or content repository 13 out over the internet or other network to thousands of displays such as displays 14 at hundreds of retail stores such as entity 11.

Additional locations such as retail store 15 with local router 30, networking interface modules 34 and displays 35 and retail store 16 with local router 40, networking interface modules 44 and displays 45 are also connected to the content repository via the network through a plurality of routers 17.

Network resident caches 20a, 20b, 20c and 20d are located close to the displays to aid in distribution of the content without dealing with a bottleneck at the central cache/content repository 13. Network resident caches 20a and 20c are within the network while network resident caches 20b and 20d are on the retail stores' LANs.

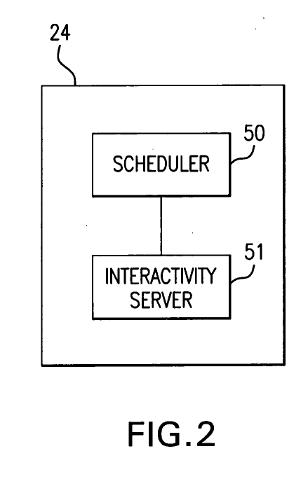

FIG. 2 depicts a diagram of the component parts of the networking interface module of the preferred embodiment of the present invention. The networking interface modules 24 of the preferred embodiment comprise a scheduler 50 and an interactivity server 51.

The scheduler 50 of each of the networking interface modules 24 operatively connects to the network resident cache and determines the amount of time that certain images or video content in a signage campaign are shown on each display. The scheduler 50 is in charge of timing information for the display of each content impression, as well as timing relative to other signage campaign content.

The interactivity server 51 of each of the networking interface modules 24 permits consumers viewing the displays at a retail location to access certain content or items of interest that have been displayed and obtain additional information about a product or service displayed from the content repository and/or network resident cache. The interactivity server 51 also connects to the scheduler 50 to stop the ordinary content on certain displays when a customer seeks additional information on a given product. The timing information, content and interaction information on which the interactivity server 51 and the scheduler 50 act are all acquired from the repository 13 through either the initial, or subsequent, display campaign distribution.

In one implementation of the preferred embodiment shown in FIG. 1, the signage campaign is comprised of images and text describing a promotion and a range of clothing. It is approved by management using a signage authoring system in the marketing head office 12 and sent to the content repository 13 to be forwarded to entity 11, retail store 15 and retail store 16 across the continent.

The signage campaign travels across the network through network routers 17, local routers 10, 30 and 40, and into network resident caches 20a, 20b, 20c and 20d for more convenient and efficiently accessed storage close to the displays 14, 35 and 45 of the entity 11, retail store 15 and retail store 16. The schedulers of the network interface modules 24, 34 and 44 allow the display of certain content from the network resident caches 20a, 20b, 20c and 20d for a certain amount of time.

A customer entering the entity 11 sees the signage displays 14 around him in many different locations around the entity 11. Eventually, the customer may notice an item being displayed of interest to him such as a shirt. If he wants more information about the shirt, he removes his cell phone from his pocket and dials a number displayed on the bottom of one of the pertinent displays 14 (e.g. 800 555-1212) to reach the interactivity server of one of the networking interface modules 24. He then enters a 6 digit sign ID (e.g. 123456) to control a chosen one of the given displays 14.

The chosen one of the displays 14 is ideally mounted on a wall above the customer with the customer standing back at such a distance as is comfortable for viewing-perhaps a meter or two with a small display or tens of meters with a very large display. The chosen one of the displays 14 presents a number of options (e.g. pictures of the various items available with numbers associated with each). There may or may not be any audio associated with the interaction. If there is audio accompanying the chosen one of the displays 14, it can be heard on the cellular phone handset only in the preferred embodiment. When the chosen one of the displays 14 shows the shirt of interest, the customer may select the accompanying code for the shirt on his phone keypad to access the network resident cache 20c through the chosen networking interface module 24, local router 10 and network router 17 to display additional information about the shirt.

The image of the shirt of interest is now displayed with color swatches along the bottom of the chosen one of the displays 14 to show available colors of the shirt. The customer may then press another number associated with the shirt to obtain directions to the shirt in the entity 11. The chosen one of the displays 14 shows the floor-plan of the entity 11 and highlights the location to find the men's shirts section.

If another customer has been watching the chosen one of the displays 14 and also likes the chosen shirt, he may also notice the location of the shirt in the entity 11 and both customers may walk to the men's section to purchase the shirt.

One alternative embodiment of the invention uses all the displays at the retail location to provide the user with a path to follow. For a few minutes each display includes a tiny thumbnail of the shirt, with an arrow indicating the direction to travel to reach the appropriate section of the retail location. The customer can follow the signs with the thumbnails all the way to the area of the store containing the selected shirt.

Another alternative embodiment of the invention uses a two-dimensional (2D) barcode in the content physically on the display housing that interacts with a cellular phone camera to initiate the interaction to allow control of the display. This can be implemented by having either a telephone number or a world-wide-web universal resource locator (URL) encoded in the barcode information, enabling the cellular phone to connect with low user effort.

In one embodiment, each display is a separately addressable entity on the network. The store's network connects to the greater continent wide network. The network is an amalgam of public networks perhaps using MPLS VPNs or other virtual links strategies. Regardless of the connectivity details below layer 4, the Public Signage Architecture comprises an authoring and approvals system, a content store, distributed caching and a scheduler. The content is sent to appropriate screens at appropriate times, and screens are combined virtually into subgroups in a hierarchical scheme.

Delivery of the public signage campaign from the marketing head office to the displays and the cellular phone access may be through different means. Displays may be joined to multicast groups based on the categories while individual interactions are unicast based sessions. IGMP commands remove a display from the group to initiate individual sessions, or re-join a display to a group of displays following completion of an individualized session. The architecture behaves similarly to an IPTV architecture without the access node elements, or residential last mile constraints.

In another embodiment, peer-to-peer content distribution can be used to facilitate the movement of display content out to widely dispersed display points. In this scheme, the marketing content is created and served to an array of display points, and that content is cached at intermediate points in the network to allow distribution without requiring a centralized content repository. Such a scheme provides better resilience, lowering susceptibility to network outages and congestion at bottleneck points.

Alternatively, displays in an XML-routed network use publish/subscribe technology. Displays issue subscriptions indicating their category information in the form of an XPATH query. Content is published to the network with the orchestration of the scheduling system, and the XML routers in the network forward the content to the displays.

The signaling from the cellular system to the networking interface modules could be through voice band and dual-tone multi-frequency (DTMF) or with an Internet protocol (IP) capable phone.

In a carrier scenario, the architecture would be a carrier operated one with a billing/accounting element to allow enterprises to use the service from their service provider. Content caching could be very effectively distributed about the wide area network to manage traffic load.

A scenario in a non-retail environment could involve selling advertising in airports with interactivity being with any of many vendors.

Another scenario is in a school system wherein a school board could provide classroom content to multiple classes across a city or many cities, while also providing other information on other displays in hallways and common areas. All displays could divert to emergency content in case of a crisis.

Applications for the invention are broad and range from advertising and promotion, to way-finding and public security.

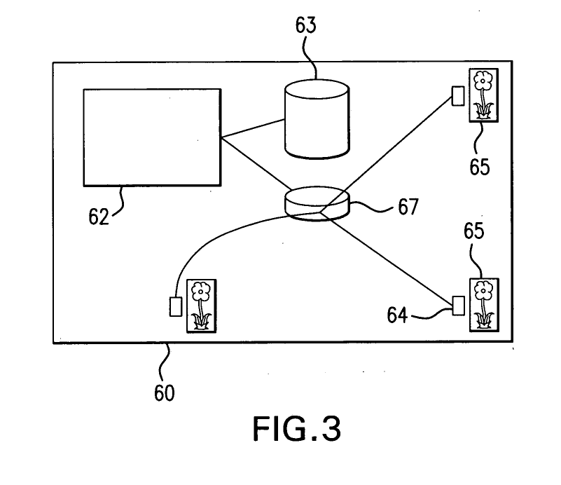

FIG. 3 depicts a diagram of an alternative embodiment of the public signage architecture of the present invention. This is a stand-alone version of the PSA 60 that does not need to be connected to a broader network. An authoring and approvals system 62 has a content repository 63 for storing images, text and audio for signage campaigns. The signage campaign can be sent through local router 67 to a plurality of networking interface modules 64 that control a plurality of displays 65.

It is contemplated that the method described herein can be implemented as software, including a computer-readable medium having program instructions executing on a computer, hardware, firmware, or a combination thereof. The method described herein also may be implemented in various combinations on hardware and/or software.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A method for interaction in a public signage architecture comprising the steps of:
(a) creating a public signage campaign;
(b) storing the public signage campaign in a content repository;
(c) sending the public signage campaign from the content repository to a networking interface module at an entity; and
(d) utilizing the networking interface module to show the public signage campaign on a display.

2. The method of claim 1 further comprising the step of:
obtaining approval for the public signage campaign prior to sending the public signage campaign from the content repository to the networking interface module.

3. The method of claim 1 further comprising the step of:
utilizing a network resident cache close to the display to store the public signage campaign.

4. The method of claim 1 further comprising the step of:
utilizing a scheduler within the networking interface module to determine an amount of time to show the public signage campaign on the display.

5. The method of claim 1 further comprising the step of:
utilizing an interactivity server within the networking interface module to interact with a customer viewing the display.

6. The method of claim 5 wherein the step of utilizing the interactivity server within the networking interface module to interact with the customer involves accessing the interactivity server through the use of a phone and a phone number by the customer.

7. The method of claim 6 further comprising the step of:
using a code and the phone by the customer to assume control of the display associated with the networking interface module.

8. The method of claim 7 further comprising the step of:
using the phone by the customer to select an item of interest on the display.

9. The method of claim 8 further comprising the step of:
showing additional information on the display related to the item of interest.

10. The method of claim 9 further comprising the step of:
showing a set of directions on the display to allow the customer to locate the item of interest at the entity.

11. The method of claim 5 wherein the step of utilizing the interactivity server within the networking interface module to interact with the customer involves accessing the interactivity server through the use of a phone and a bar code on the display connected to the networking interface module.

12. A method for interaction in a public signage architecture comprising the steps of:
(a) obtaining a public signage campaign at a repository;
(b) sending the public signage campaign from the repository to a plurality of networking interface modules connected to a plurality of displays;
(c) showing the public signage campaign on at least one of the plurality of displays; and
(d) utilizing at least one of the plurality of networking interface modules to interact with an individual viewing at least one of the plurality of displays.

13. The method of claim 12 wherein the step of utilizing at least one of the plurality of networking interface modules to interact with an individual involves using a code and a phone by the individual to assume control of one of the plurality of displays through one of the plurality of networking interface modules.

14. A public signage architecture comprising:
(a) a signage authoring system;
(b) a content repository operatively connected to the signage authoring system;
(c) a plurality of networking interface modules each having a scheduler and an interactivity server wherein the scheduler is operatively connected to the content repository and the interactivity server is operatively connected to the scheduler; and
(d) a plurality of displays associated with the plurality of networking interface modules.

15. The architecture of claim 14 wherein the scheduler controls the length of time a public signage campaign obtained from the content repository appears on each of the plurality of displays.

16. The architecture of claim 14 further comprising:
a signage approval system operatively connected to the signage authoring system.

17. A device for interacting with a content repository and a plurality of displays in a public signage architecture comprising:
(a) a scheduler; and
(b) an interactivity server.

18. The device of claim 17 wherein the scheduler is operatively connected to the content repository and the interactivity server is operatively connected to the scheduler and to at least one of the plurality of displays.

19. A device for use within a networking interface module comprising:
a server that is connected to a scheduler and a display and that can be accessed and controlled by a cellular phone.
